(19) United States
(12) Patent Application Publication
(10) Pub. No.: US 2017/0316432 A1
(43) Pub. Date: Nov. 2, 2017

(54) A/B TESTING ON DEMAND

(71) Applicant: LinkedIn Corporation, Mountain View, CA (US)

(72) Inventors: Ya Xu, Los Altos, CA (US); Kylan Matthem Nieh, Fremont, CA (US); Jie Bing, Sunnyvale, CA (US); Luisa Fernanda Hurtado Jaramillo, Sunnyvale, CA (US); Bryan Tai An Chen, San Jose, CA (US); Christina Lynn Lopus, San Francisco, CA (US); Adrian Axel Remigio Fernandez, Mountain View, CA (US); Omar Sinno, San Francisco, CA (US); Nanyu Chen, San Francisco, CA (US)

(21) Appl. No.: 15/140,186

(22) Filed: Apr. 27, 2016

(51) Int. Cl. G06Q 30/02; G06F 3/0484; G06F 11/36; G06Q 50/00

(52) U.S. Cl. CPC G06Q 30/0201; G06Q 50/01; G06F 3/0484; G06F 11/3664

(57) ABSTRACT

A machine may be configured to generate A/B test reports on demand. For example, the machine causes a display of a user interface for receiving a request of a customized report of result data of an A/B test. The machine receives, via the user interface, an identifier of the A/B test, a specification of a metric associated with the result data, a specification of a dimension of the metric, a specification of a location of the result data, and a request to generate the customized report. The machine generates the metric based on the identifier of the A/B test, the specification of the metric, and the result data. The machine generates the customized report pertaining to the dimension of the metric based on the generated metric and the specification of the dimension of the metric. The machine causes a display of the customized report in the user interface.

### TECHNICAL FIELD

The present application relates generally to data processing systems and, in one specific example, to techniques for generating A/B experiments and A/B test reports on demand.

### BACKGROUND

The practice of A/B experimentation, also known as “A/B testing” or “split testing,” is a practice for making improvements to webpages and other online content. A/B experimentation typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a functional diagram of an example system, according to various embodiments;

FIG. 3 is a block diagram of an example system, according to various embodiments;

FIG. 4 is a flowchart illustrating an example method, according to various embodiments;

FIG. 5 is a flowchart illustrating an example method, according to various embodiments;

FIG. 6 is a flowchart illustrating an example method, according to various embodiments;

FIG. 7 is a flowchart illustrating an example method, according to various embodiments;

FIG. 8 is a flowchart illustrating an example method, according to various embodiments;

FIG. 9 is a flowchart illustrating an example method, according to various embodiments;

FIG. 10 illustrates an example portion of a user interface, according to various embodiments;

FIG. 11 illustrates an example portion of a user interface, according to various embodiments;

FIG. 12 illustrates an example portion of a metric schema, according to various embodiments;

FIG. 13 illustrates an example portion of a user interface, according to various embodiments;

FIG. 14 illustrates an example portion of an assignment schema for assigning a member to a variant of an experiment, according to various embodiments;

FIG. 15 illustrates an example mobile device, according to various embodiments; and

FIG. 16 is a diagrammatic representation of a machine in the example form of a computer system within which a set of instructions, for causing the machine to perform any one or more of the methodologies discussed herein, may be executed.

### DETAILED DESCRIPTION

Example methods and systems for generating AB test reports on demand are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, an on-demand A/B testing and reporting system (also referred to hereinafter as “an on-demand A/B reporting system,” or “an A/B reporting system”) enables an experiment administrator or owner to conduct an on-demand A/B experiment of online content among users of an online social networking service (also “SNS”) such as LinkedIn®, and to generate a report based on the test result data of the A/B experiment. The A/B reporting system may also facilitate a customization of an existing A/B test such that the experiment administrator has more control over the A/B test and can request on-demand A/B test reports. An A/B reporting system that facilitates customization of A/B testing and reporting may include functionalities for providing the experiment administrator with options to select from existing metrics or to define a new metric, to select from existing metric dimensions (or fields) or to define new metric dimensions, to select a pre-existing assignment of users targeted by the A/B test or to define a new assignment of the target users to different variants of the A/B test, to select or to specify a preferred time period for which A/B tests should run or A/B test reports should be generated, etc.

An on-demand A/B reporting system that executes A/B tests that are customized on-demand and generates on-demand A/B test reports (hereinafter also “A/B reports”) provides an increased level of flexibility in A/B experimentation related to publishing of online content, operation of computer systems and database systems providing the online content, and operation of the network systems that facilitate the traffic to and from the systems providing the online content. Further, the on-demand A/B reporting system also provides the benefit of timely, on-demand execution of A/B tests or generation of A/B test reports that may be customized to particular (e.g., urgent) situations. Such on-demand A/B testing or reporting may be helpful in fast identification of system errors and, therefore, in providing more stable and robust computer, database, and network systems that facilitate generating, publishing, hosting, or accessing of online content.

In some example embodiments, an A/B reporting system causes a display of a user interface for receiving a request of a customized report of result data of an A/B test of online content. The user interface is caused to display on a client device associated with a user (e.g., a user of the SNS). The result data of the A/B test may be generated based on an execution of the A/B test by an A/B test system (e.g., the A/B reporting system). The A/B reporting system receives, via one or more input elements of the user interface displayed on the client device, an identifier of the A/B test, an identifier (e.g., a name or a specification) of a metric associated with the result data of the A/B test, an identifier (e.g., a name or a specification) of a dimension of the metric, an identifier (e.g., a name, a specification, or an address) of a location of the result data of the A/B test in a database associated with the A/B test system, and a request to generate the customized report. The dimension of the metric may be a data field of the metric. The A/B reporting system may also receive, via one or more input elements of the user interface, a specification of a time (e.g., a time range) for which to generate the customized report. The A/B reporting system accesses the result data of the A/B test from the database associated with the A/B test system based on the specification of the location of the result data. The A/B reporting system generates, using one or more hardware processors, the metric based on the identifier of the A/B test, the identifier of the metric, and the result data of the A/B test. The A/B reporting system, based on (e.g., in response to) the request to generate the customized report, generates the customized report pertaining to the dimension of the metric on demand based on the generated metric and the identifier of the dimension of the metric. The A/B reporting system causes a display of the customized report in an output element of the user interface of the client device associated with the user.

In some example embodiments, if a desired metric does not exist, a user of the A/B reporting system may provide a script for generating (e.g., calculating) the metric by the A/B reporting system. The user may provide the script by identifying a location of the script via the one or more input elements of the user interface displayed on the client device. The A/B reporting system may execute the script, and may assign the resulting value to the metric.

According to various examples embodiments, the A/B reporting system receives, via the one or more input elements of the user interface displayed on the client device, a specification of an assignment of one or more members of a social networking service (SNS) to one or more variants of the A/B test, and a request to execute the A/B test based on the specification of the assignment. The A/B reporting system, in response to the request to execute the A/B test, executes the A/B test based on the specification of the assignment. The executing of the A/B test results in a generation of the result data of the A/B test.

According to various example embodiments, to run an experiment, the A/B reporting system allows a user to create a testKey, which is a unique identifier that represents the concept or the feature to be tested. The A/B reporting system then creates an actual experiment as an instantiation of the testKey, and there may be multiple experiments associated with a testKey. Such hierarchical structure makes it easy to manage experiments at various stages of the testing process. For example, suppose the user wants to investigate the benefits of adding a background image. The user may begin by diverting only 1% of US users to the treatment, then increasing the allocation to 50% and eventually expanding to users outside of the US market. Even though the feature being tested remains the same throughout the ramping process, it requires different experiment instances as the traffic allocations and targeting changes. In other words, an experiment acts as a realization of the testKey, and only one experiment per testKey can be active at a time.

Every experiment is comprised of one or more segments, with each segment identifying a subpopulation to experiment on. For example, a user may set up an experiment with a “whitelist” segment containing only the team members developing the product, an “internal” segment consisting of all company employees and additional segments targeting external users. Because each segment defines its own traffic allocation, the treatment can be ramped to 100% in the whitelist segment, while still running at 1% in the external segments. Note that segment ordering matters because members are only considered as part of the first eligible segment. After the experimenters input their design through an intuitive User Interface, all the information is then concisely stored by the A/B reporting system in a DSL (Domain Specific Language). For example, the line below indicates a single segment experiment targeting English-speaking users in the US where 10% of them are in the treatment variant while the rest in control.

(ab (=(locale)“en_US”)[treatment 10% control 90%])

In some embodiments, the A/B reporting system may log data every time a treatment for an experiment is called, and not simply for every request to a webpage on which the treatment might be displayed. This not only reduces the logs footprint, but also enables the A/B reporting system to perform triggered analysis, where only users who were actually impacted by the experiment are included in the A/B test analysis. For example, LinkedIn.com could have 20 million daily users, but only 2 million of them visited the “jobs” page where the experiment is actually on, and even fewer viewed the portion of the “jobs” page where the experiment treatment is located. Without such trigger information, it is difficult to isolate the real impact of the experiment from the noise, especially for experiments with low trigger rates.

Conventional A/B testing reports may not accurately represent the global lift that will occur when the winning treatment is ramped to 100% of the targeted segment (holding everything else constant). The reason is two-fold. Firstly, most experiments only target a subset of the entire user population (e.g., US users using an English language interface, as specified by the command “interface-locale=en_US”). Secondly, most experiments only trigger for a subset of their targeted population (e.g., members who actually visit a profile page where an experiment resides). In other words, triggered analysis only provides evaluation of the local impact, not the global impact of an experiment.

According to various example embodiments, the A/B reporting system is configured to compute a Site-wide Impact value, defined as the percentage delta between two scenarios or “parallel universes”: one with treatment applied to only targeted users and control to the rest, the other with control applied to all. Put another way, the site-wide impact is the x % delta if a treatment is ramped to 100% of its targeting segment. With site-wide impact provided for all experiments, users are able to compare results across experiments regardless of their targeting and triggering conditions. Moreover, Site-wide Impact from multiple segments of the same experiment can be added up to give an assessment of the total impact.

For most metrics that are additive across days, the A/B reporting system may simply keep a daily counter of the global total and add them up for any arbitrary date range. However, there are metrics, such as the number of unique visitors, which are not additive across days. Instead of computing the global total for all date ranges that the A/B reporting system generates reports for, the A/B reporting system estimates them based on the daily totals, saving more than 99% of the computation cost without sacrificing a great deal of accuracy.

In some embodiments, the average number of clicks is utilized as an example metric to show how the A/B reporting system computes Site-wide Impact. Let Xₜ, X_{c}, X_{seg} and X_{global} denote the total number of clicks in the treatment group, the control group, the whole segment (including the treatment, the control and potentially other variants) and globally across the site, respectively. Similarly, let nₜ, n_{c}, n_{seg} and n_{global} denote the sample sizes for each of the four groups mentioned above.

The total number of clicks in the treatment (control) universe can be estimated as:

$${X}_{tUniverse} = \frac{{X}_{t}}{{n}_{t}} {n}_{seg} + ( {X}_{global} - {X}_{seg} )$$

$${X}_{cUniverse} = \frac{{X}_{c}}{{n}_{c}} {n}_{seg} + ( {X}_{global} - {X}_{seg} )$$

Then the Site-wide Impact is computed as

$$\begin{matrix}SWI = ( \frac{{X}_{tUniverse}}{{n}_{tUniverse}} - \frac{{X}_{cUniverse}}{{n}_{cUniverse}} ) / \frac{{X}_{cUniverse}}{{n}_{cUniverse}} \\ = ( \frac{\frac{{X}_{t}}{{n}_{t}} - \frac{{X}_{c}}{{n}_{c}}}{\frac{{X}_{c}}{{n}_{c}}} ) \times ( \frac{\frac{{X}_{c}}{{n}_{c}} {n}_{seg}}{\frac{{X}_{c}}{{n}_{c}} {n}_{seg} + {X}_{global} - {X}_{seg}} ) \\ = Δ \times α\end{matrix}$$

which indicates that the Site-wide Impact is essentially the local impact Δ scaled by a factor of α. For metrics such as average number of clicks, Xglobal for any arbitrary date range can be computed by summing over clicks from corresponding single days. However, for metrics such as average number of unique visitors, de-duplication is necessary across days. To avoid having to compute α for all date ranges that the A/B reporting system generate reports for, the A/B reporting system estimates cross-day α by averaging the single-day α's. Another group of metrics include a ratio of two metrics. One example is Click-Through-Rate, which equals Clicks over Impressions. The derivation of Site-wide Impact for ratio metrics is similar, with the sample size replaced by the denominator metric.

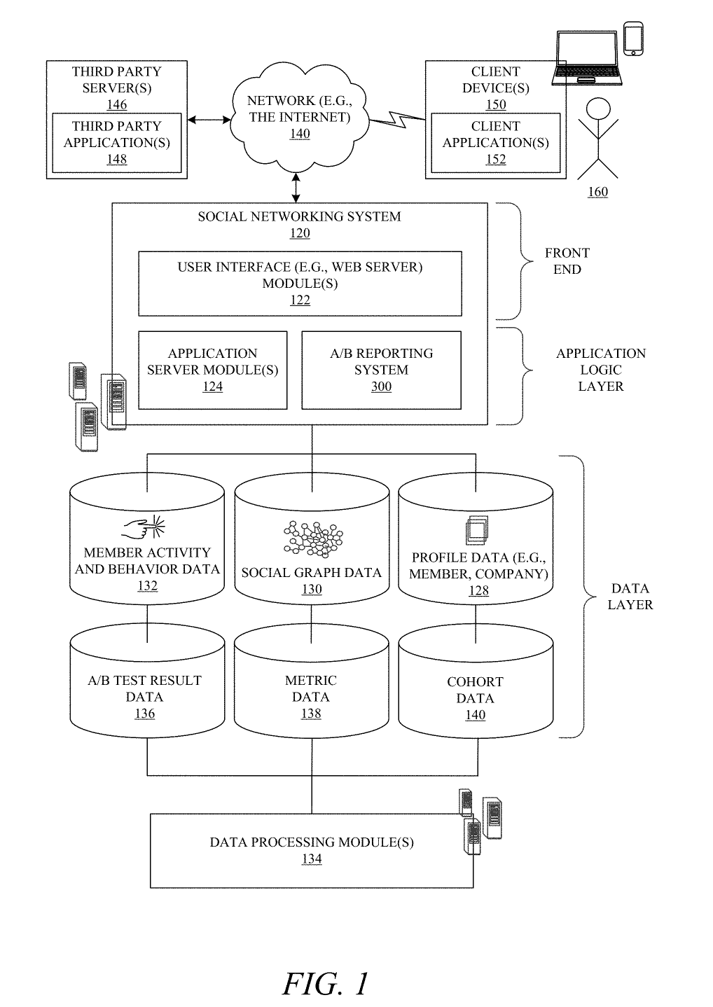

FIG. 1 is a block diagram illustrating various components or functional modules of a social network service such as the social network system 120, consistent with some embodiments. As shown in FIG. 1, the front end consists of a user interface module (e.g., a web server) 122, which receives requests from various client computing devices including one or more client device(s) 150, and communicates appropriate responses to the requesting client devices. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social network system 120. Each of the client devices 150 may comprise a computing device that includes at least a display and communication capabilities with the network 140 to access the social network system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social network system 120 via the client device(s) 150. The user(s) 160 may not be part of the networked environment, but may be associated with client device(s) 150.

The application logic layer includes various application server modules 124, which, in conjunction with the user interface module(s) 122, generates various user interfaces (e.g., web pages) with data retrieved from various data sources in the data layer. With some embodiments, individual application server modules 124 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 124. Similarly, a variety of other applications or services that are made available to members of the social network service will be embodied in their own application server modules 124.

As shown in FIG. 1, the data layer includes several databases, such as a database 128 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 128. Similarly, when a representative of an organization initially registers the organization with the social network service, the representative may be prompted to provide certain information about the organization. This information may be stored, for example, in the database with reference number 128, or another database. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database, shown in FIG. 1 with reference number 130.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored or tracked, and information concerning the member's activities and behavior may be stored, for example, as indicated in FIG. 1 in the database with reference number 132.

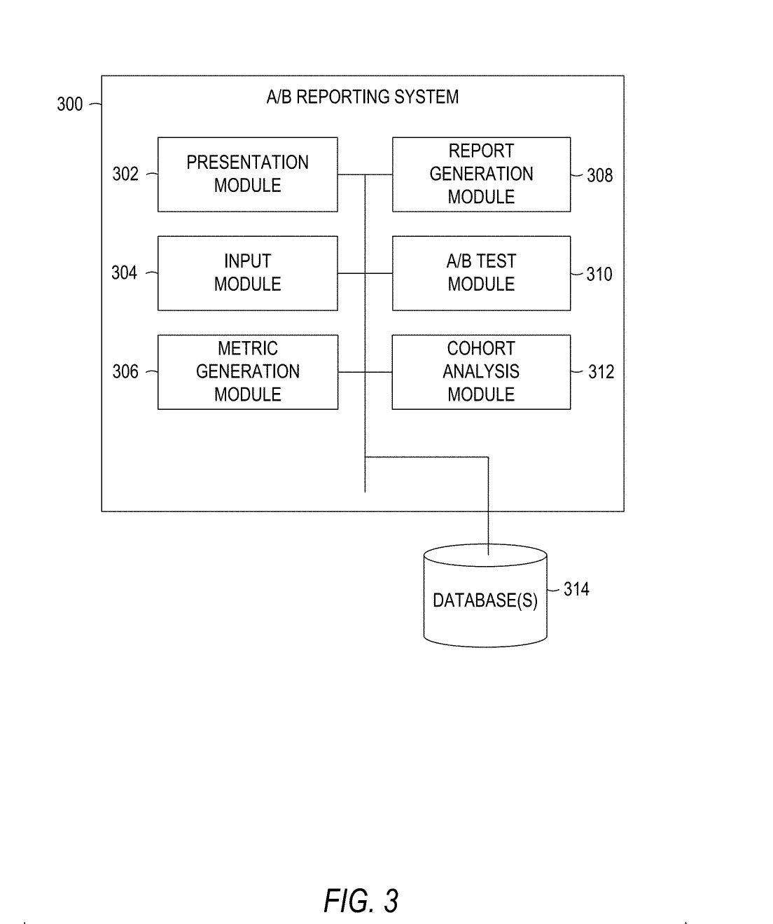

With some embodiments, the social network system 120 includes what is generally referred to herein as an A/B reporting system 300. The A/B reporting system 300 is described in more detail below in conjunction with FIG. 3.

Additionally, a third-party application(s) 148, executing on a third-party server(s) 146, is shown as being communicatively coupled to the social network system 120 and the client device(s) 150. The third-party server(s) 146 may support one or more features or functions on a web site hosted by the third party.

Although not shown, with some embodiments, the social network system 120 provides an application programming interface (API) module via which third-party applications 148 can access various services and data provided by the social network service. For example, using an API, a third-party application 148 may provide a user interface and logic that enables an authorized representative of an organization to publish messages from a third-party application 148 to a content hosting platform of the social network service that facilitates presentation of activity or content streams maintained and presented by the social network service. Such third-party applications 148 may be browser-based applications, or may be operating system-specific. In particular, some third-party applications 148 may reside and execute on one or more mobile devices (e.g., phone, or tablet computing devices) having a mobile operating system.

Further, as shown in FIG. 1, a data processing module 134 may be used with a variety of applications, services, and features of the social network system 120. The data processing module 134 may periodically access one or more of the databases 128, 130, 132, 136, 138, or 140, process (e.g., execute batch process jobs to analyze or mine) profile data, social graph data, member activity and behavior data, A/B test result data, metric data, or cohort data, and generate analysis results based on the analysis of the respective data. The data processing module 134 may operate offline. According to some example embodiments, the data processing module 134 operates as part of the social network system 120. Consistent with other example embodiments, the data processing module 134 operates in a separate system external to the social network system 120. In some example embodiments, the data processing module 134 may include multiple servers of a large-scale distributed storage and processing framework, such as Hadoop servers, for processing large data sets. The data processing module 134 may process data in real time, according to a schedule, automatically, or on demand.

According to various example embodiments, an A/B experimentation system, such as A/B reporting system 300, is configured to enable a user of the A/B reporting system 300 to prepare and conduct an A/B experiment of online content among users (e.g., actual members or potential members/guests) of an online social networking service (also “SNS”) such as LinkedIn®. The A/B experimentation system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). In some embodiments, the member attribute is any of location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. For example, the user can enter targeting criteria such as “role is sales”, “industry is technology”, “connection count >500”, “account is premium”, and so on, and the system will identify a targeted segment of members of an online social network service satisfying all of these criteria. The system can then target all of these users in the targeted segment for online A/B experimentation.

Once the segment of users to be targeted has been defined, the system allows the user to define different variants for the experiment, such as by uploading files, images, HTML code, webpages, data, etc., associated with each variant and providing a name for each variant. One of the variants may correspond to an existing feature or variant, also referred to as a “control” variant, while the other may correspond to a new feature being tested, also referred to as a “treatment”. For example, if the A/B experiment is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display a user interface allowing the user to allocate different variants to different percentages of the targeted segment of users. For example, the user may allocate variant A to 10% of the targeted segment of members, variant B to 20% of the targeted segment of members, and a control variant to the remaining 70% of the targeted segment of members, via an intuitive and easy to use user interface. The user may also change the allocation criteria by, for example, modifying the aforementioned percentages and variants. Moreover, the user may instruct the system to execute the A/B experiment, and the system will identify the appropriate percentages of the targeted segment of members and expose them to the appropriate variants.

In some example embodiments, the A/B reporting system 300 facilitates a customization of an A/B test and/or of reports generated based on result data of an A/B test. The A/B reporting system 300 may cause the display of a user interface for customization of a request to execute an A/B test on demand, or for customization of a request to generate an A/B test report on demand. The user interface may be caused to display on a client device 150 that is associated with a user 160 (e.g., an actual or potential member) of the SNS. The user interface may include a number of input elements (e.g., fields, drop-down menus, buttons, etc.) to receive input, by the user 160, to be used in the customization of an A/B test or of an A/B test report. Based on receiving the input and a request to execute the A/B test on demand (or a request to generate an on-demand, customized A/B test report) provided by the user 160 via the user interface displayed on the client device 150, the A/B reporting system 300 executes the A/B test on-demand (or generates the on-demand, customized A/B test report). The A/B reporting system 300 may cause a display of the on-demand, customized A/B test report in an output element of the user interface of the client device 150 associated with the user 160.

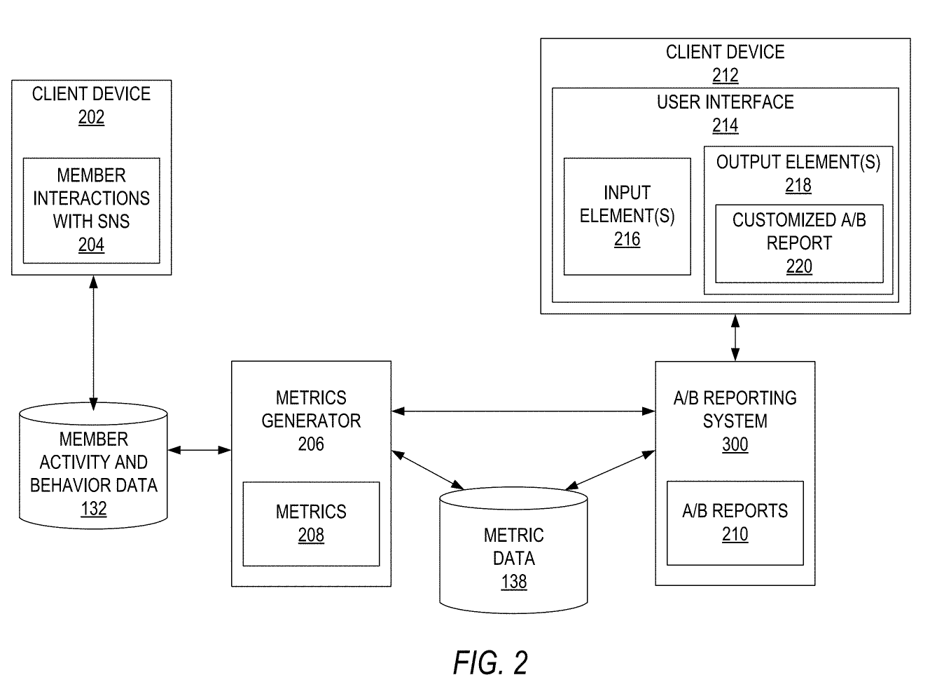

FIG. 2 illustrates a functional diagram of an example system, according to various embodiments. A user 160 of the SNS may interact, via client device 202, with online content provided by the SNS. The social networking system 120 may track the member interactions 204 with the SNS, and may store data about the member interactions 204 in a record of the member activity and behavior database 132.

A metrics generator 206 may access member activity and behavior data from the member activity and behavior database 132, and may generate one or more metrics 208 based on the member activity and behavior data. The metrics generator 206 may store the metrics 208 in a record of the metric database 138. In some example embodiments, the metrics generator 206 is included in (e.g., is a module of) the A/B reporting system 300.

The A/B reporting system 300 may execute customized A/B tests, and may generate customized A/B reports 210 based on one or more preferences of a user of the A/B reporting system 300. The one or more preferences of a user of the A/B reporting system 300 may represent one or more customization criteria provided by the user for the customization of an A/B test or the customization of an A/B test report 210. In some example embodiments, the generating of the customized A/B reports 210 includes accessing the metrics 208 from the metrics generator 206 or from the metric database 138. In certain example embodiments, a first module of the A/B reporting system 300 generates the metrics 208, and a second module of the A/B reporting system 300 generates the customized A/B reports 210.

The A/B reporting system 300 may receive (e.g., access) the one or more preferences of the user from the client device 212. The client device 212 may be associated with an administrator of the A/B reporting system 300 (e.g., an experiment owner, a metrics owner, an executive of a company, etc.). The A/B reporting system 300 may cause the display of a user interface 214 for receiving a request to perform a customized A/B test, or for receiving a request for a customized A/B test report on the client device 212. The user interface 214 may include one or more input elements 216 (e.g., a field, a drop-down menu, a button, a list of selection options) for receiving input data from the user of the client device 212, and one or more output elements 218 (e.g., a window, a field, an area, etc.) for presenting a customized A/B report 220 in the user interface 214.

Turning now to FIG. 3, an A/B reporting system 300 includes a presentation module 302, an input module 304, a metric generation module 306, a report generation module 308, an A/B test module 310, and a cohort analysis module 312, and a database 314. In some instances, the database 314 is external to the A/B reporting system 300.

The modules of the A/B reporting system 300 may be implemented on or executed by a single device, such as an A/B testing device, or on separate devices interconnected via a network. The aforementioned A/B testing device may be, for example, one or more client machines or application servers. The operation of each of the aforementioned modules of the A/B reporting system 300 will now be described in greater detail in conjunction with the various figures.

In some example embodiments, the presentation module 302 causes a display of a user interface for receiving a request of a customized report of result data of an A/B test of online content. The user interface may be caused to display on a client device associated with a user. The result data of the A/B test may be generated based on an execution of the A/B test by an A/B test system.

The input module 304 receives, via one or more input elements of the user interface displayed on the client device, an identifier of the A/B test, a specification of a metric associated with the result data of the A/B test, a specification of a dimension of the metric, the dimension being a data field of the metric, a specification of a location of the result data of the A/B test in a database associated with the A/B test system, an identifier of a time (e.g., a time range), a request to generate the customized report, or a suitable combination thereof.

In some example embodiments, the one or more elements of the user interface include a metric input element that presents an option to select the metric from one or more existing metrics associated with the result data of the A/B test. In some example embodiments, the one or more elements of the user interface include a metric input element that presents an option to define the metric. The metric may be defined by a user of the A/B reporting system 300.

In certain example embodiments, the one or more elements of the user interface include a dimension input element that presents an option to select a product-level dimension from one or more dimensions associated with the metric. The product-level dimension may represent a feature of a product. An example of a product-level dimension is a device type (e.g., a desktop, a tablet, a smartphone, a specific brand of a device, etc.). For instance, a metric name “pageviews” may be associated with a product-level dimension “device type” that has a value of “iPhone.”

In various example embodiments, the one or more elements of the user interface include a dimension input element that presents an option to select a member-level dimension from one or more dimensions associated with the metric. The member-level dimension may represent an attribute associated with a member of the SNS. Examples of attributes associated with a member are a title, an industry, a seniority level, a geographical location, etc. According to some example embodiments, the one or more elements of the user interface include a dimension input element that presents an option to define the dimension. The dimension may be defined by a user of the A/B reporting system 300.

The metric generation module 306 accesses the result data of the A/B test from the database associated with the A/B test system based on the specification of the location of the result data. The metric generation module 306 also generates the metric based on the identifier of the A/B test, the specification of the metric, and the result data of the A/B test.

The report generation module 308 generates the customized report pertaining to the dimension of the metric based on the generated metric and the specification of the dimension of the metric.

The presentation module 302 causes a display of the customized report in an output element of the user interface of the client device associated with the user.

The A/B test module 310 executes A/B tests. In some example embodiments, the input module 302 receives, via the one or more input elements of the user interface displayed on the client device, a specification of an assignment of one or more members of the SNS to one or more variants of the A/B test, and a request to execute the A/B test based on the specification of the assignment. The A/B test module 310 executes the A/B test based on the specification of the assignment. The executing results in a generation of the result data of the A/B test.

The cohort analysis module 312 performing a cohort analysis pertaining to a cohort. In some example embodiments, the cohort includes a number of members of the SNS who exhibited a particular behavior during a particular period of time. According to various example embodiments, the input module 302 receives a specification of a cohort via the one or more elements of the user interface of the client device. The cohort analysis module 312 identifies the result data of the A/B test pertaining to the cohort based on member identifiers of the members of the cohort, and performs a cohort analysis pertaining to the cohort based on the result data of the A/B test identified to pertain to the cohort and result data generated during a post-A/B test period of monitoring activity of the members of the cohort.

To perform one or more of its functionalities, the A/B reporting system 300 may communicate with one or more other systems. For example, an integration engine may integrate the A/B reporting system 300 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 314 (e.g., database 128, 130, 132, 136, 138, or 140).

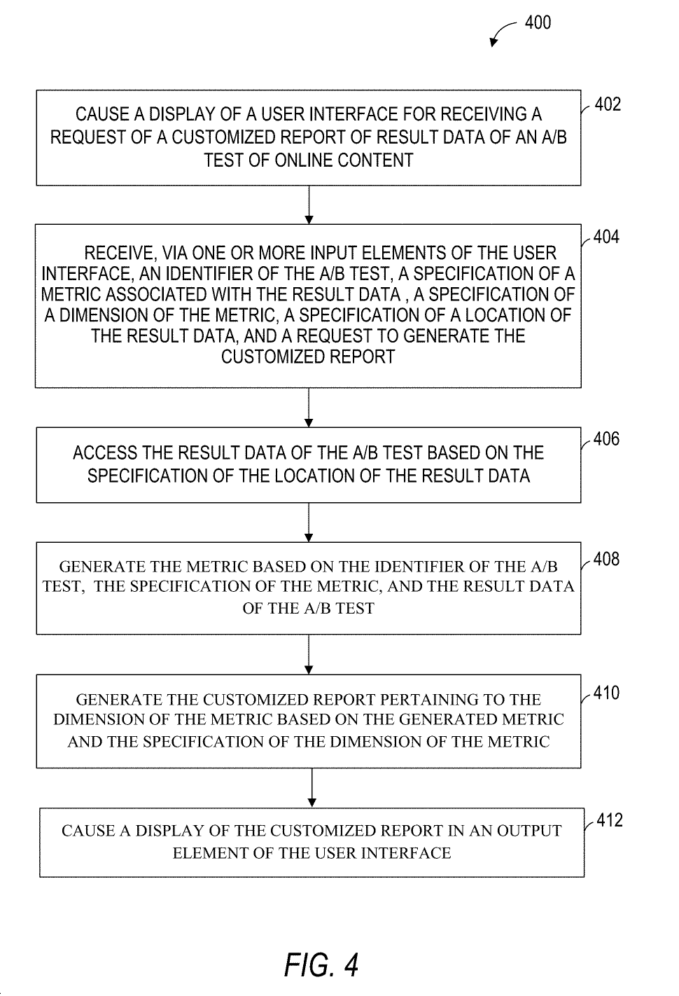

FIG. 4 is a flowchart illustrating an example method 400, consistent with various embodiments described herein. The method 400 may be performed at least in part by, for example, the A/B reporting system 300 illustrated in FIG. 3 (or an apparatus having similar modules, such as one or more client machines or application servers).

At operation 402, the presentation module 302 causes a display of a user interface for receiving a request of a customized report of result data of an A/B test of online content. The user interface is caused to display on a client device associated with a user. The result data of the A/B test may be generated based on an execution of the A/B test by an A/B test system.

At operation 404, the input module 304 receives, via one or more input elements of the user interface displayed on the client device, an identifier of the A/B test, a specification of a metric associated with the result data of the A/B test, a specification of a dimension of the metric, the dimension being a data field of the metric, a specification of a location of the result data of the A/B test in a database associated with the A/B test system, and a request to generate the customized report. The input module 304 receives, via one or more input elements of the user interface displayed on the client device, an identifier of a time (e.g., a time range).

In some example embodiments, the one or more elements of the user interface include a metric input element that presents an option to select the metric from one or more existing metrics associated with the result data of the A/B test. In certain example embodiments, the one or more elements of the user interface include a dimension input element that presents an option to select a product-level dimension from one or more dimensions associated with the metric. The product-level dimension represents a feature of a product. In various example embodiments, the one or more elements of the user interface include a dimension input element that presents an option to select a member-level dimension from one or more dimensions associated with the metric. The member-level dimension represents an attribute associated with a member of the SNS. Consistent with some example embodiments, the one or more elements of the user interface include a dimension input element that presents an option to define the dimension.

At operation 406, the metric generation module 306 accesses the result data of the A/B test from the database associated with the A/B test system based on the specification of the location of the result data.

At operation 408, the metric generation module 306 generates the metric based on the identifier of the A/B test, the specification of the metric, and the result data of the A/B test.

At operation 410, the report generation module 308 generates the customized report pertaining to the dimension of the metric based on the generated metric and the specification of the dimension of the metric.

At operation 412, the presentation module 302 causes a display of the customized report in an output element of the user interface of the client device associated with the user.

It is contemplated that the operations of method 400 may incorporate any of the other features disclosed herein. Various operations in the method 400 may be omitted or rearranged, as necessary.

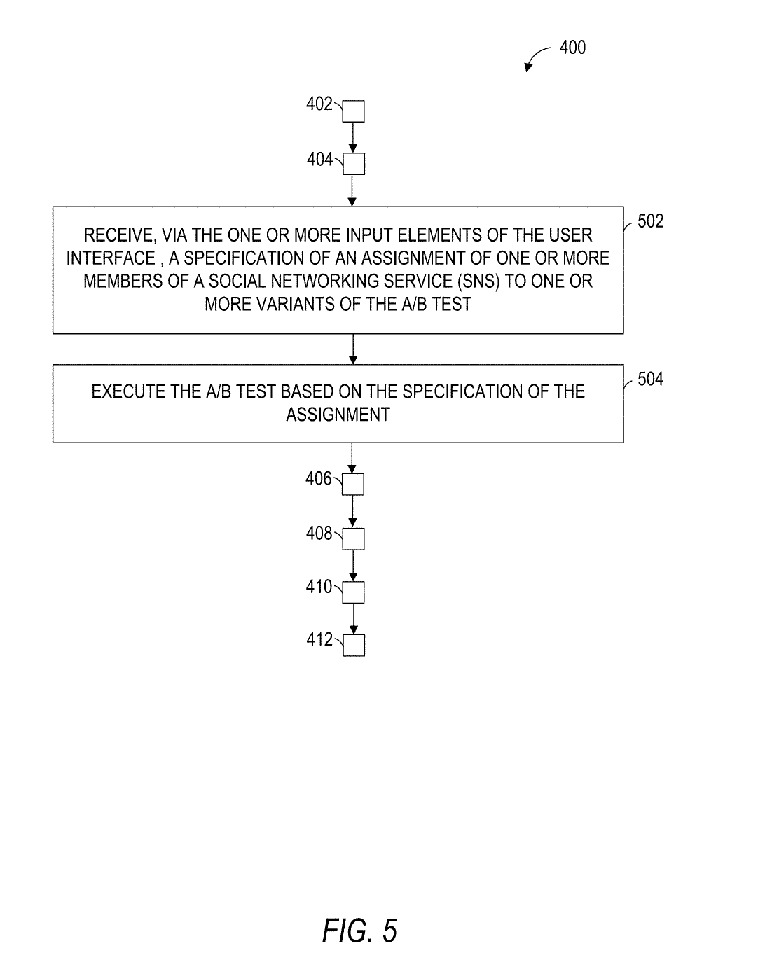

As shown in FIG. 5, method 400 may include one or more of operations 502 or 504, according to some example embodiments. Operation 502 may be performed after operation 404, in which the input module 304 receives, via one or more input elements of the user interface displayed on the client device, an identifier of the A/B test, a specification of a metric associated with the result data of the A/B test, a specification of a dimension of the metric, the dimension being a data field of the metric, a specification of a location of the result data of the A/B test in a database associated with the A/B test system, and a request to generate the customized report.

At operation 502, the input module 30 receives, via the one or more input elements of the user interface displayed on the client device, a specification of an assignment of one or more members of a social networking service (SNS) to one or more variants of the A/B test, and a request to execute the A/B test based on the specification of the assignment.

Operation 504 is performed after operation 502. At operation 504, the A/B test module 310 executes the A/B test based on the specification of the assignment. The executing results in a generation of the result data of the A/B test.

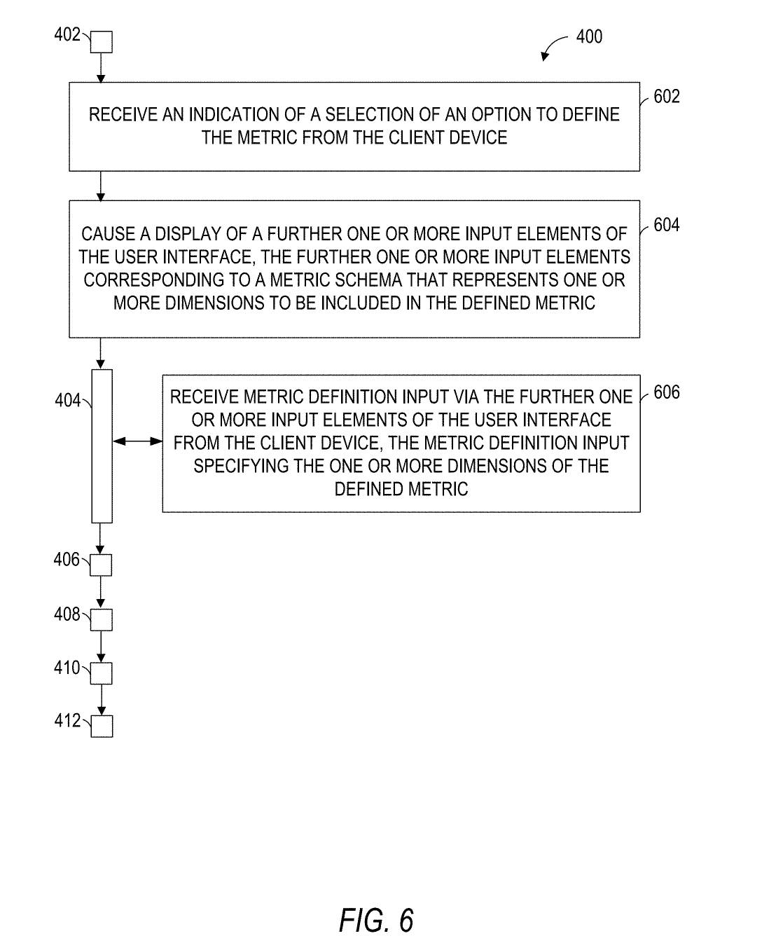

As shown in FIG. 6, method 400 may include one or more of operations 602, 604, or 606, according to some example embodiments. Operation 602 may be performed after operation 402, in which the presentation module 302 causes a display of a user interface for receiving a request of a customized report of result data of an A/B test of online content. In some example embodiments, the one or more elements of the user interface include a metric input element that presents an option to define the metric.

At operation 602, the input module 304 receives an indication of a selection of the option to define the metric from the client device associated with the user.

Operation 604 may be performed after operation 602. At operation 604, the presentation module 302 causes a display of a further one or more input elements of the user interface. The further one or more input elements correspond to a metric schema that represents one or more dimensions to be included in the defined metric.

Operation 606 may be performed as part (e.g., a precursor task, a subroutine, or a portion) of operation 404, in which the input module 304 receives, via one or more input elements of the user interface displayed on the client device, an identifier of the A/B test, a specification of a metric associated with the result data of the A/B test, a specification of a dimension of the metric, the dimension being a data field of the metric, a specification of a location of the result data of the A/B test in a database associated with the A/B test system, and a request to generate the customized report. At operation 606, the input module 304 receives metric definition input via the further one or more input elements of the user interface from the client device. The metric definition input may specify the one or more dimensions of the defined metric.

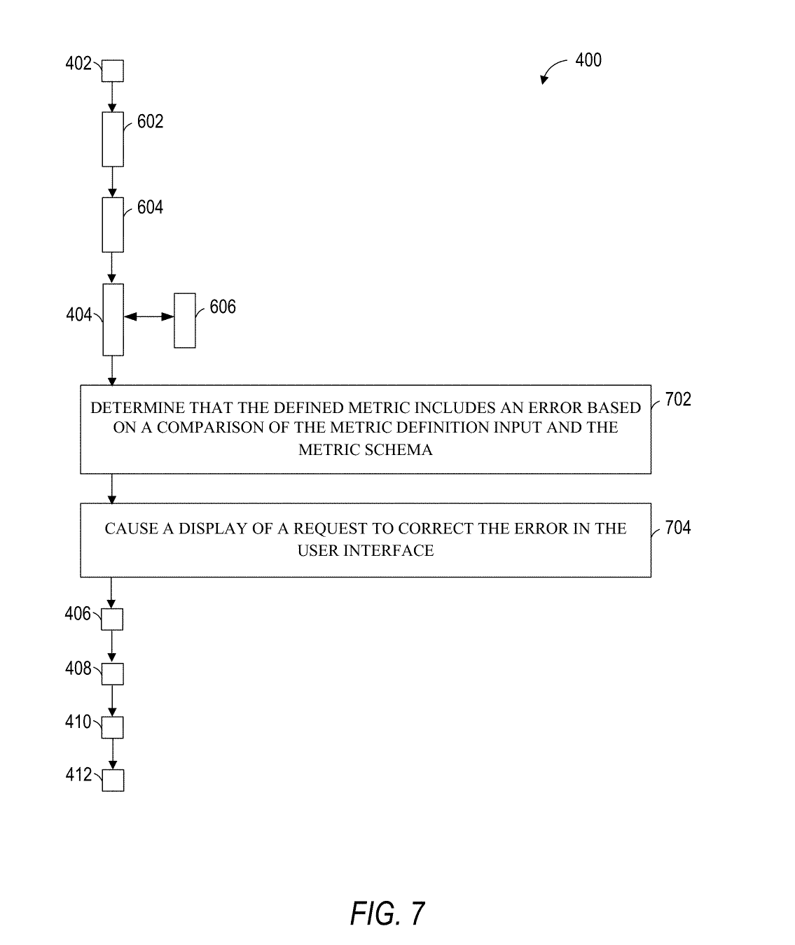

As shown in FIG. 7, method 400 may include one or more of operations 702 or 704, according to some example embodiments. Operation 702 may be performed after operation 606 of method 400 illustrated in FIG. 6, in which the input module 304 receives metric definition input via the further one or more input elements of the user interface from the client device.

At operation 702, the input module 304 determines that the defined metric includes an error based on a comparison of the metric definition input and the metric schema.

Operation 702 may be performed after operation 702. At operation 704, the presentation module 302 causes a display of a request to correct the error in the user interface of the client device.

The input module 304 may, in response to the presentation module 302 causing a display of a request to correct the error, receive additional input via the further one or more input elements of the user interface from the client device. The additional input may include corrected metric definition input.

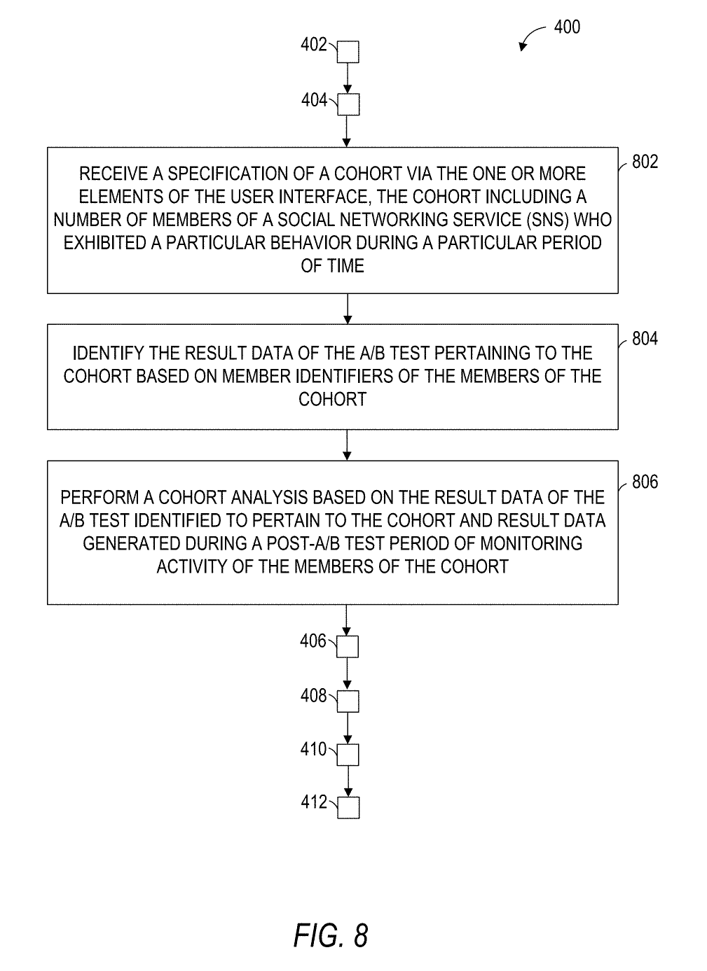

As shown in FIG. 8, method 400 may include one or more of the operations 802, 804, or 806, according to some example embodiments. Operation 802 may be performed after operation 404, in which the input module 304 receives, via one or more input elements of the user interface displayed on the client device, an identifier of the A/B test, a specification of a metric associated with the result data of the A/B test, a specification of a dimension of the metric, the dimension being a data field of the metric, a specification of a location of the result data of the A/B test in a database associated with the A/B test system, and a request to generate the customized report.

At operation 802, the input module 304 receives a specification (e.g., a list of member identifiers of members of the SNS) of a cohort via the one or more elements of the user interface of the client device. In some example embodiments, the cohort includes a number of members of the SNS who exhibited a particular behavior during a particular period of time. In some example embodiments, the cohort includes a number of members of the SNS who have a member attribute in common.

At operation 804, the cohort analysis module 312 identifies the result data of the A/B test pertaining to the cohort based on member identifiers of the members of the cohort.

At operation 806, the cohort analysis module 312 performs a cohort analysis pertaining to the cohort. The cohort analysis may be based on the result data of the A/B test identified to pertain to the cohort, result data generated during a post-A/B test period of monitoring activity of the members of the cohort, or both.

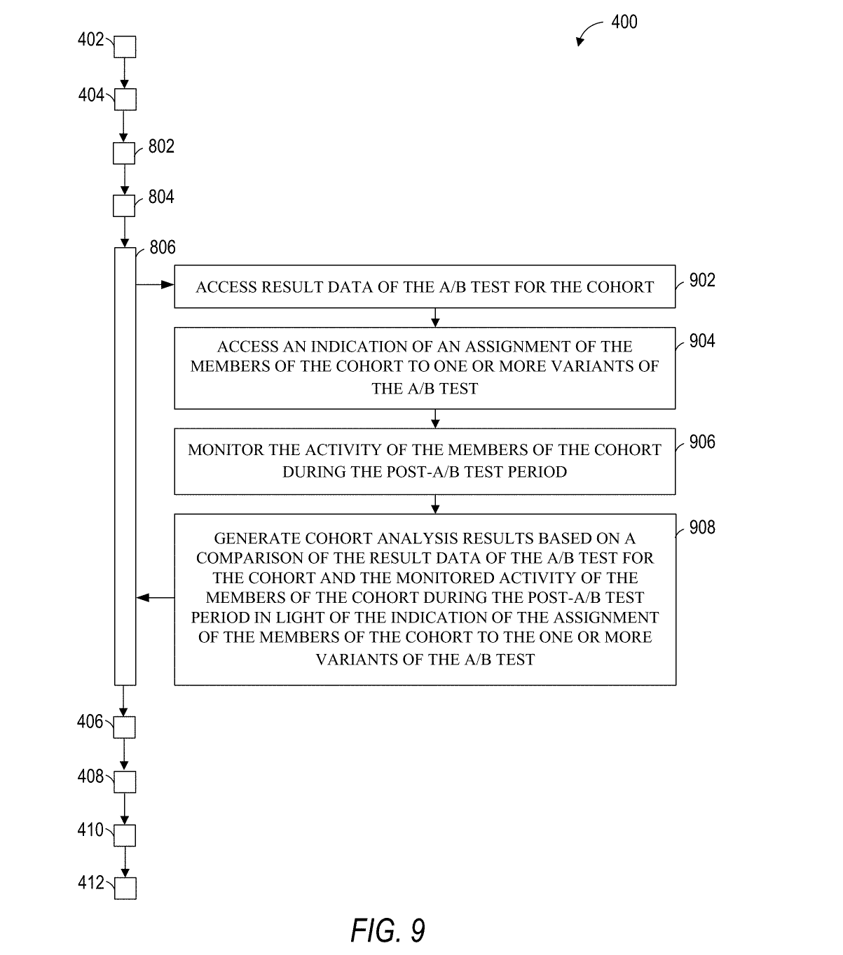

As shown in FIG. 9, method 400 may include one or more of the operations 902, 904, 906, or 908, according to some example embodiments. Operation 902 may be performed as part of operation 806 of method 400 illustrated in FIG. 8, in which the cohort analysis module 312 performs a cohort analysis pertaining to the cohort.

At operation 902, the cohort analysis module 312 accesses the result data of the A/B test pertaining to the cohort. The result data of the A/B test pertaining to the cohort may be stored in and accessed from a record of the cohort database 140.

At operation 904, the cohort analysis module 312 accesses an indication of an assignment of the members of the cohort to one or more variants of the A/B test. In some instances, the indication of an assignment of the members of the cohort to one or more variants of the A/B test may be received from the client device. In certain instances, the indication of an assignment of the members of the cohort to one or more variants of the A/B test may be stored in and accessed from a record of the cohort database 140.

At operation 906, the cohort analysis module 312 monitors the activity of the members of the cohort during the post-A/B test period. The monitoring of the activity of the members of the cohort may be based on tracking interactions by the members of the cohort with the SNS during the post-A/B test period. The tracking of interactions by the members of the cohort with the SNS may be performed by one or more modules of the A/B reporting system 300 or by another system associated with the social networking system 120.

At operation 908, the cohort analysis module 312 generates cohort analysis results based on a comparison of the result data of the A/B test identified to pertain to the cohort and the monitored activity of the members of the cohort during the post-A/B test period in light of the indication of the assignment of the members of the cohort to the one or more variants of the A/B test.

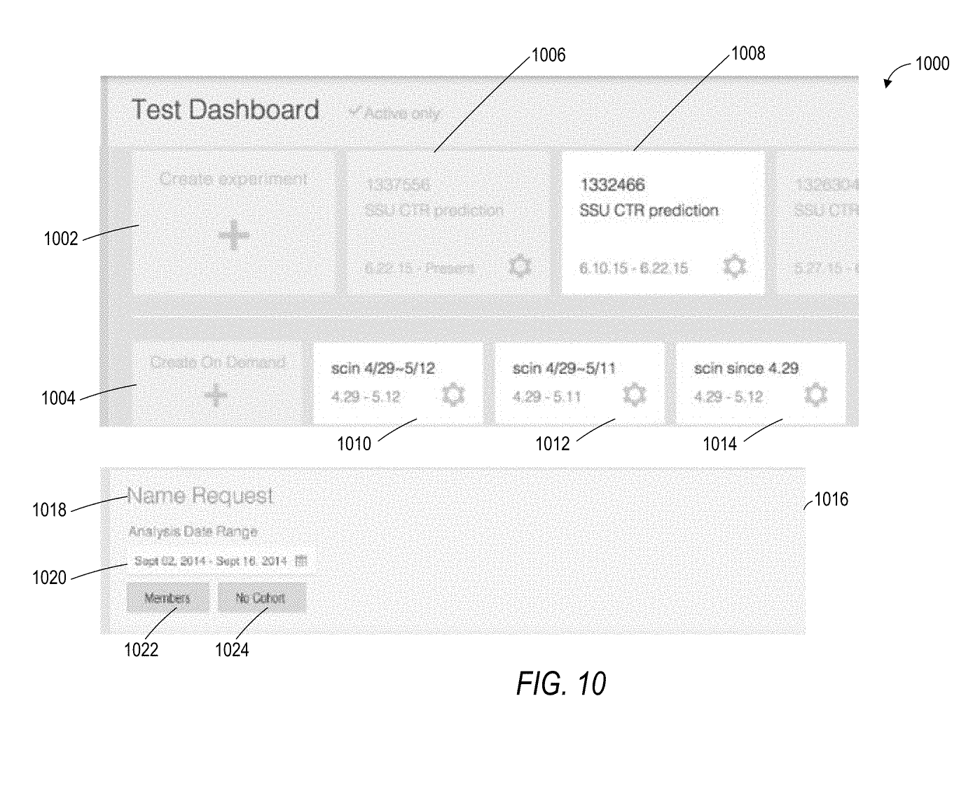

FIG. 10 illustrates an example portion of a user interface 1000, according to various embodiments. The user interface is displayed on a client device associated with a user of the A/B reporting system 300, such as an experiment owner, a metric owner, an executive of a company, etc. As shown in FIG. 10, the user interface 1000 may include an area for requesting the generating of A/B experiments (e.g., area 1002) and an area for requesting the generating of A/B test reports on demand (e.g., area 1004). By selecting area 1002, the user may request the generation of an A/B experiment. By selecting area 1004, the user may request the generation of an A/B test report on demand.

The user interface 1000 may display information about existing A/B experiments. For example, area 1006 displays identifier “1337556” for the existing experiment “SSU CTR prediction” for the time range “6.22.2015-Present.” Area 1008 displays identifier “1332466” for existing experiment “SSU CTR prediction” for the time range “6.10.2015-6.22.2015.”

The user interface 1000 may also display information about existing A/B test reports. For example, area 1010 identifies the test report “scin” for the time range “4/29-5/12,” area 1012 identifies the test report “scin” for the time range “4/29-5/11,” and area 1014 identifies the test report “scin” for the time starting on “4/29.”

As shown in FIG. 10, area 1016 of user interface 1000 facilitates the input, by the user, of a name for an on-demand A/B test report via input element 1018, and of a time (e.g., a date range) associated with the data for the analysis performed in generating the requested A/B test report via input element 1020. In some example embodiments, the data should already exist and be stored in a record of a database associated with the A/B reporting system 300. In various example embodiments, if the requested date range spans multiple experiments or ramps of an experiment, the traffic allocation of the variants should remain consistent during the date range.

The user interface 1000 also includes a button 1022 to facilitate the indication, by the user, that the A/B experiment is a member-based experiment, and a button 1024 to indicate that the analysis is not a cohort analysis.

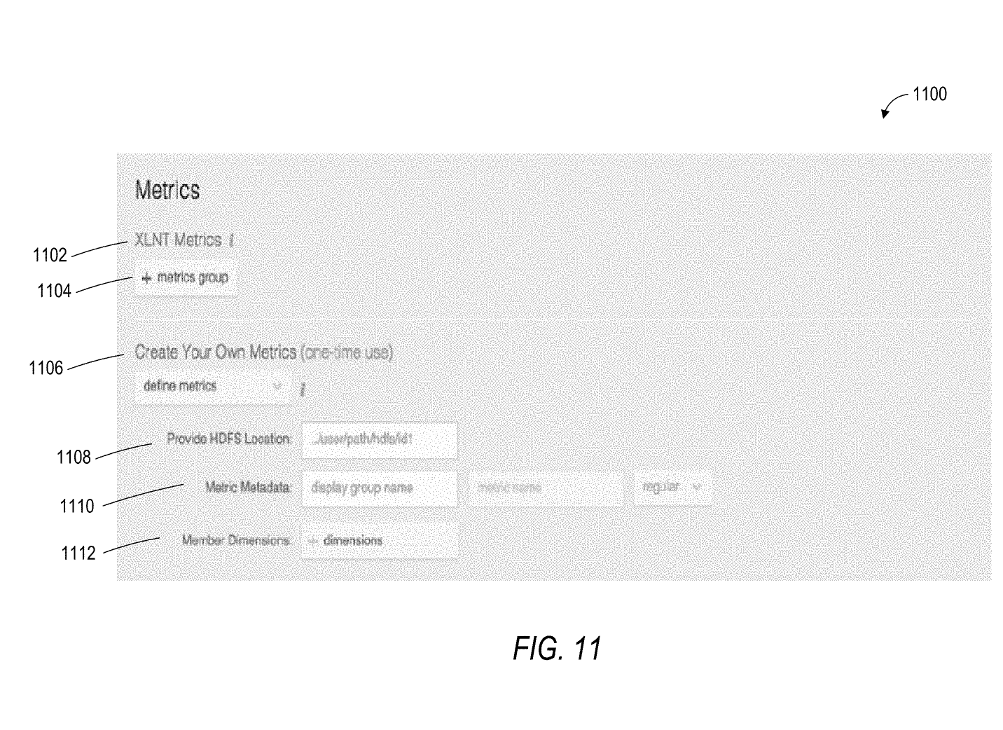

FIG. 11 illustrates an example portion of a user interface 1100, according to various embodiments. A user may have an option 1102 to select an existing metric for an on-demand A/B test report, or an option 1106 to request the generation of a new metric. The drop-down menu 1104 facilitates a selection, by the user, of a metric from one or more existing metrics. Various input elements of the user interface 1110 facilitate the specification, by the user, of various information pertaining to the user-defined metric. For example, input element 1108 is used to provide a specification of a location of the user-defined metrics for the A/B test in a database associated with the A/B test system, input element 1110 is used to provide metric metadata, and input element 1112 is used to provide a specification of (e.g., to select) a dimension of the metric. The dimension of the metric may be a data field of the metric.

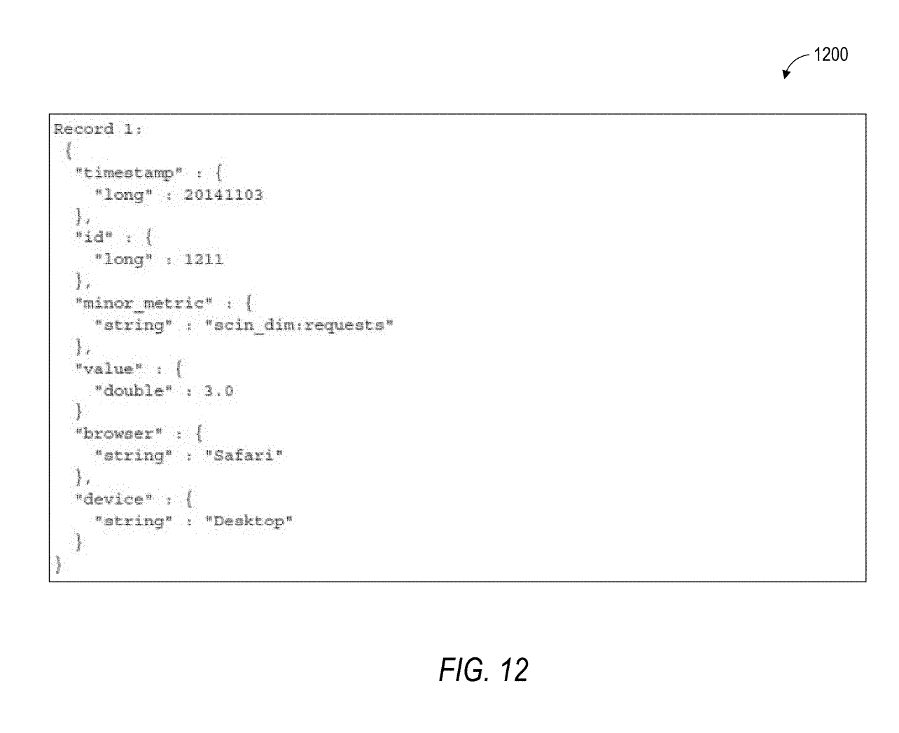

FIG. 12 illustrates an example portion of a file that specifies the fields of a metric schema, according to various example embodiments. In some example embodiments, the user-defined metric should comport with the metric schema. The A/B reporting system 300 may, in response to receiving metric definition input for the user-defined metric, determine that the defined metric includes an error based on a comparison of the metric definition input and the metric schema. The A/B reporting system 300 may cause a display of a request to correct the error in the user interface of the client device, and may, in response to the displaying of the request to correct the error, receive further input to correct the error.

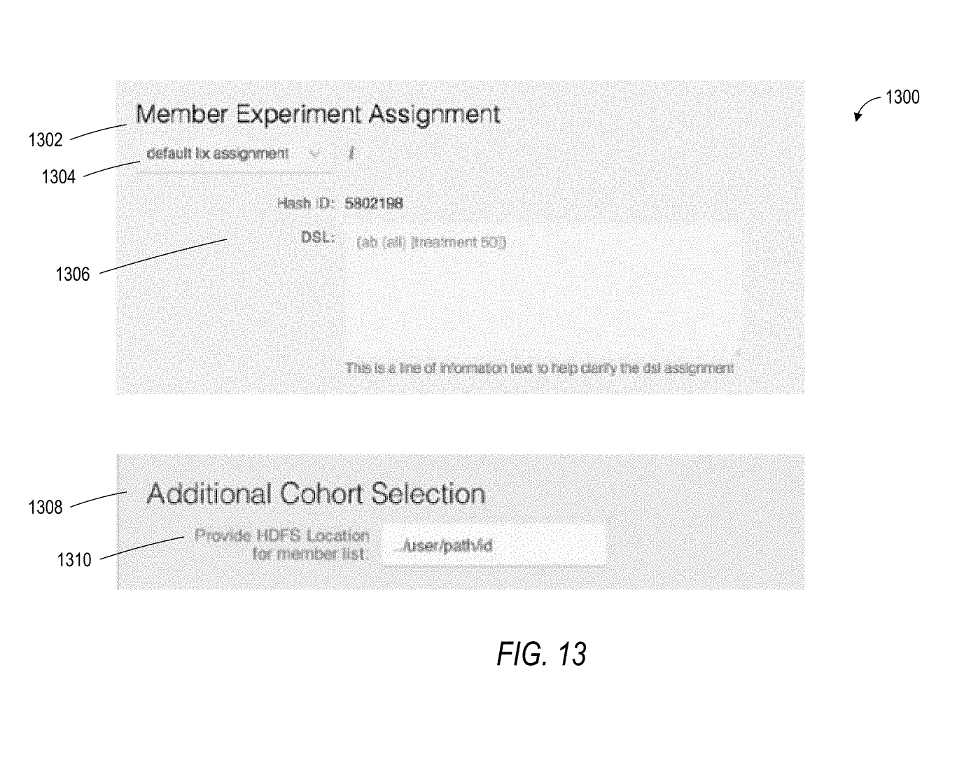

FIG. 13 illustrates an example portion of a user interface 1300, according to various embodiments. Area 1302 of the user interface 1300 may facilitate the specification of the assignment, by the user, of members to various treatments of an A/B experiment. For example, the user may select an existing assignment of members from a drop-down menu 1304. The determining of the member assignment to an experiment, by the A/B reporting system 300, may be based on the testkey associated with the experiment and based on the selected date range.

Alternately, the user may request, via area 1306 of the user interface 1300, a customized assignment of members to variants of an A/B experiment. In some example embodiments, the user defines the experiment population by providing a member list that includes identifiers of members.

As shown in FIG. 13, area 1308 of the user interface 1300 facilitates the additional cohort selection by the user. Input element 1310 of the user interface 1300 facilitates the providing, by the user, of a location of a member list of the members included in the cohort. In some example embodiments, the member list is a file that includes one or more member identifiers (e.g., member IDs) and that is stored in cohort database 140.

In some example embodiments, by default, the cohort is defined as the members who are included in the experiment population. In certain example embodiments, if the user provides a list of member IDs as the cohort, the A/B reporting system 300 filters down the experiment population to include only the members included in the cohort.

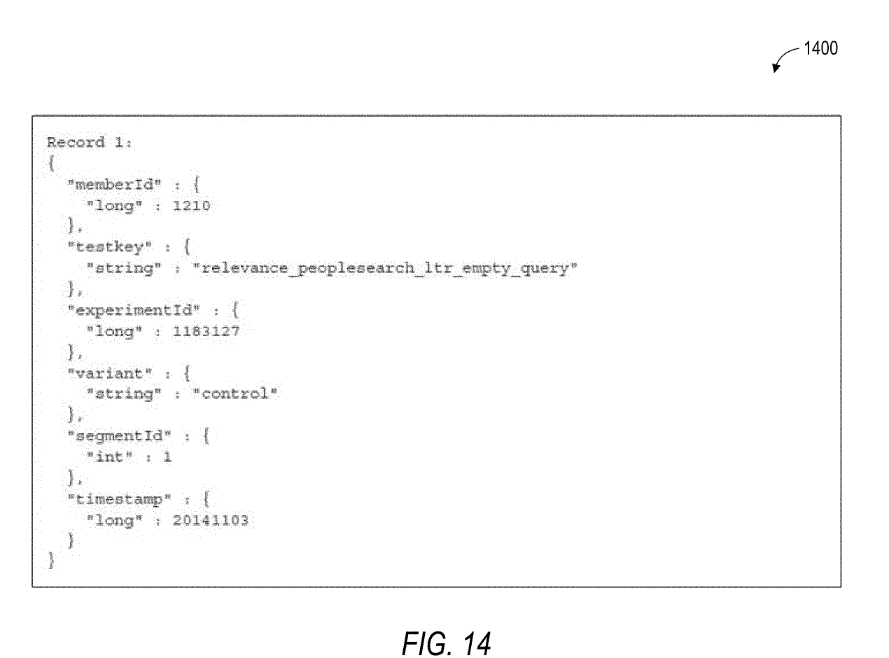

FIG. 14 illustrates an example portion of a file that specifies the fields of an assignment schema for a customized assignment file, according to various example embodiments. In some example embodiments, the user-defined member assignment should comport with the assignment schema.

The A/B reporting system 300 may, in response to receiving a customized assignment file for the customized member assignment, determine that the customized assignment file includes an error based on a comparison of the customized assignment file and the assignment schema. The A/B reporting system 300 may cause a display of a request to correct the error in the user interface of the client device, and may, in response to the displaying of the request to correct the error, receive further input to correct the error.

### Example Mobile Device

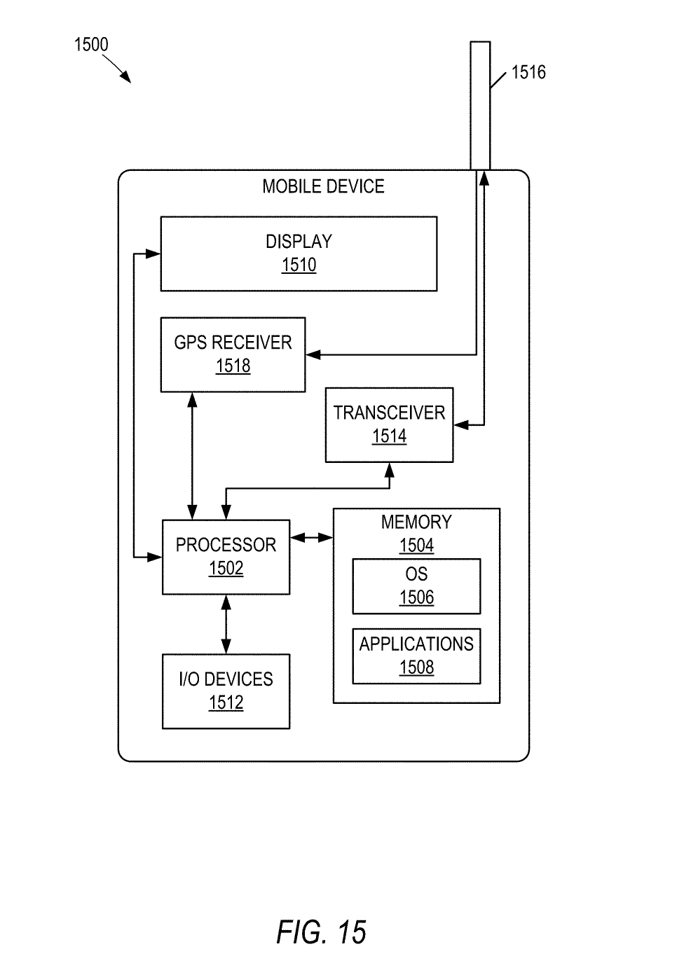

FIG. 15 is a block diagram illustrating the mobile device 1500, according to an example embodiment. The mobile device may correspond to, for example, one or more client machines or application servers. One or more of the modules of the system 200 illustrated in FIG. 2 may be implemented on or executed by the mobile device 1500. The mobile device 1500 may include a processor 1502. The processor 1502 may be any of a variety of different types of commercially available processors 1502 suitable for mobile devices 1500 (for example, an XScale architecture microprocessor, a microprocessor without interlocked pipeline stages (MIPS) architecture processor, or another type of processor 1502). A memory 1504, such as a random access memory (RAM), a flash memory, or other type of memory, is typically accessible to the processor 1502. The memory 1504 may be adapted to store an operating system (OS) 1506, as well as application programs 1508, such as a mobile location enabled application that may provide LBSs to a user. The processor 1502 may be coupled, either directly or via appropriate intermediary hardware, to a display 1510 and to one or more input/output (I/O) devices 1512, such as a keypad, a touch panel sensor, a microphone, and the like. Similarly, in some embodiments, the processor 1502 may be coupled to a transceiver 1514 that interfaces with an antenna 1516. The transceiver 1514 may be configured to both transmit and receive cellular network signals, wireless data signals, or other types of signals via the antenna 1516, depending on the nature of the mobile device 1500. Further, in some configurations, a GPS receiver 1518 may also make use of the antenna 1516 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

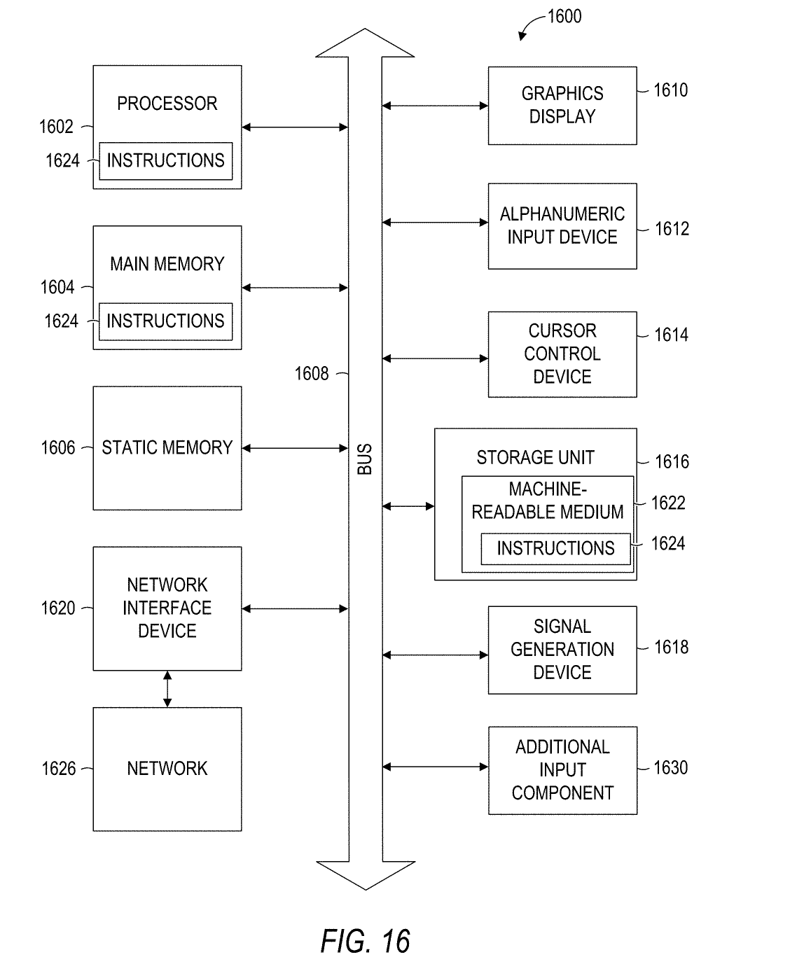

FIG. 16 is a block diagram illustrating components of a machine 1600, according to some example embodiments, able to read instructions 1624 from a machine-readable medium 1622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 16 shows the machine 1600 in the example form of a computer system (e.g., a computer) within which the instructions 1624 (e.g., software, a program, an application, an applet, an app, or other executable code) for causing the machine 1600 to perform any one or more of the methodologies discussed herein may be executed, in whole or in part.

In alternative embodiments, the machine 1600 operates as a standalone device or may be connected (e.g., networked) to other machines. In a networked deployment, the machine 1600 may operate in the capacity of a server machine or a client machine in a server-client network environment, or as a peer machine in a distributed (e.g., peer-to-peer) network environment. The machine 1600 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1624, sequentially or otherwise, that specify actions to be taken by that machine. Further, while only a single machine is illustrated, the term “machine” shall also be taken to include any collection of machines that individually or jointly execute the instructions 1624 to perform all or part of any one or more of the methodologies discussed herein.

The machine 1600 includes a processor 1602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1604, and a static memory 1606, which are configured to communicate with each other via a bus 1608. The processor 1602 may contain microcircuits that are configurable, temporarily or permanently, by some or all of the instructions 1624 such that the processor 1602 is configurable to perform any one or more of the methodologies described herein, in whole or in part. For example, a set of one or more microcircuits of the processor 1602 may be configurable to execute one or more modules (e.g., software modules) described herein.

The machine 1600 may further include a graphics display 1610 (e.g., a plasma display panel (PDP), a light emitting diode (LED) display, a liquid crystal display (LCD), a projector, a cathode ray tube (CRT), or any other display capable of displaying graphics or video). The machine 1600 may also include an alphanumeric input device 1612 (e.g., a keyboard or keypad), a cursor control device 1614 (e.g., a mouse, a touchpad, a trackball, a joystick, a motion sensor, an eye tracking device, or other pointing instrument), a storage unit 1616, an audio generation device 1618 (e.g., a sound card, an amplifier, a speaker, a headphone jack, or any suitable combination thereof), and a network interface device 1620.

The storage unit 1616 includes the machine-readable medium 1622 (e.g., a tangible and non-transitory machine-readable storage medium) on which are stored the instructions 1624 embodying any one or more of the methodologies or functions described herein. The instructions 1624 may also reside, completely or at least partially, within the main memory 1604, within the processor 1602 (e.g., within the processor's cache memory), or both, before or during execution thereof by the machine 1600. Accordingly, the main memory 1604 and the processor 1602 may be considered machine-readable media (e.g., tangible and non-transitory machine-readable media). The instructions 1624 may be transmitted or received over the network 1626 via the network interface device 1620. For example, the network interface device 1620 may communicate the instructions 1624 using any one or more transfer protocols (e.g., hypertext transfer protocol (HTTP)).

In some example embodiments, the machine 1600 may be a portable computing device, such as a smart phone or tablet computer, and have one or more additional input components 1630 (e.g., sensors or gauges). Examples of such input components 1630 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1624 for execution by the machine 1600, such that the instructions 1624, when executed by one or more processors of the machine 1600 (e.g., processor 1602), cause the machine 1600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing a display of a user interface for receiving a request of a customized report of result data of an A/B test of online content, the user interface being caused to display on a client device associated with a user, the result data of the A/B test being generated based on an execution of the A/B test by an A/B test system;
receiving, via one or more input elements of the user interface displayed on the client device,
an identifier of the A/B test,
a specification of a metric associated with the result data of the A/B test,
a specification of a dimension of the metric, the dimension being a data field of the metric,
a specification of a location of the result data of the A/B test in a database associated with the A/B test system, and
a request to generate the customized report;
accessing the result data of the A/B test from the database associated with the A/B test system based on the specification of the location of the result data;
generating, using one or more hardware processors, the metric based on the identifier of the A/B test, the specification of the metric, and the result data of the A/B test;
generating the customized report pertaining to the dimension of the metric based on the generated metric and the specification of the dimension of the metric; and
causing a display of the customized report in an output element of the user interface of the client device associated with the user.

2. The method of claim 1, further comprising:
receiving, via the one or more input elements of the user interface displayed on the client device,
a specification of an assignment of one or more members of a social networking service (SNS) to one or more variants of the A/B test, and
a request to execute the A/B test based on the specification of the assignment; and
executing the A/B test based on the specification of the assignment, the executing resulting in a generation of the result data of the A/B test.

3. The method of claim 1, wherein the one or more elements of the user interface include a metric input element that presents an option to define the metric, the method further comprising:
receiving an indication of a selection of the option to define the metric from the client device associated with the user; and
causing a display of a further one or more input elements of the user interface, the further one or more input elements corresponding to a metric schema that represents one or more dimensions to be included in the defined metric,
wherein the receiving of the specification of the metric includes receiving metric definition input via the further one or more input elements of the user interface from the client device, the metric definition input specifying the one or more dimensions of the defined metric.

4. The method of claim 3, further comprising:
determining that the defined metric includes an error based on a comparison of the metric definition input and the metric schema; and
causing a display of a request to correct the error in the user interface of the client device.

5. The method of claim 1, wherein the one or more elements of the user interface include a metric input element that presents an option to select the metric from one or more existing metrics associated with the result data of the A/B test.

6. The method of claim 1, wherein the one or more elements of the user interface include a dimension input element that presents an option to select a product-level dimension from one or more dimensions associated with the metric, the product-level dimension representing a feature of a product.

7. The method of claim 1, wherein the one or more elements of the user interface include a dimension input element that presents an option to select a member-level dimension from one or more dimensions associated with the metric, the member-level dimension representing an attribute associated with a member of the social network service (SNS).

8. The method of claim 1, wherein the one or more elements of the user interface include a dimension input element that presents an option to define the dimension.

9. The method of claim 1, further comprising:
receiving a specification of a cohort via the one or more elements of the user interface of the client device, the cohort including a number of members of a social networking service (SNS) who exhibited a particular behavior during a particular period of time;
identifying the result data of the A/B test pertaining to the cohort based on member identifiers of the members of the cohort; and
performing a cohort analysis pertaining to the cohort based on the result data of the A/B test identified to pertain to the cohort and result data generated during a post-A/B test period of monitoring activity of the members of the cohort.

10. The method of claim 9, wherein the performing of the cohort analysis includes:
accessing the result data of the A/B test pertaining to the cohort;
accessing an indication of an assignment of the members of the cohort to one or more variants of the A/B test;
monitoring the activity of the members of the cohort during the post-A/B test period based on tracking interactions by the members of the cohort with the SNS during the post-A/B test period; and
generating cohort analysis results based on a comparison of the result data of the A/B test identified to pertain to the cohort and the monitored activity of the members of the cohort during the post-A/B test period in light of the indication of the assignment of the members of the cohort to the one or more variants of the A/B test.

11. A system comprising:
one or more hardware processors; and
a machine-readable medium for storing instructions that, when executed by one or more hardware processors, cause the one or more hardware processors to perform operations comprising:
causing a display of a user interface for receiving a request of a customized report of result data of an A/B test of online content, the user interface being caused to display on a client device associated with a user, the result data of the A/B test being generated based on an execution of the A/B test by an A/B test system;
receiving, via one or more input elements of the user interface displayed on the client device,
an identifier of the A/B test,
a specification of a metric associated with the result data of the A/B test,
a specification of a dimension of the metric, the dimension being a data field of the metric,
a specification of a location of the result data of the A/B test in a database associated with the A/B test system, and
a request to generate the customized report;
accessing the result data of the A/B test from the database associated with the A/B test system based on the specification of the location of the result data;
generating the metric based on the identifier of the A/B test, the specification of the metric, and the result data of the A/B test;
generating the customized report pertaining to the dimension of the metric based on the generated metric and the specification of the dimension of the metric; and
causing a display of the customized report in an output element of the user interface of the client device associated with the user.

12. The system of claim 11, wherein the operations further comprise:
receiving, via the one or more input elements of the user interface displayed on the client device,
a specification of an assignment of one or more members of a social networking service (SNS) to one or more variants of the A/B test, and
a request to execute the A/B test based on the specification of the assignment; and
executing the A/B test based on the specification of the assignment, the executing resulting in a generation of the result data of the A/B test.

13. The system of claim 1, wherein the one or more elements of the user interface include a metric input element that presents an option to define the metric, wherein the operations further comprise:
receiving an indication of a selection of the option to define the metric from the client device associated with the user; and
causing a display of a further one or more input elements of the user interface, the further one or more input elements corresponding to a metric schema that represents one or more dimensions to be included in the defined metric, and
wherein the receiving of the specification of the metric includes receiving metric definition input via the further one or more input elements of the user interface from the client device, the metric definition input specifying the one or more dimensions of the defined metric.

14. The system of claim 13, wherein the operations further comprise:
determining that the defined metric includes an error based on a comparison of the metric definition input and the metric schema; and
causing a display of a request to correct the error in the user interface of the client device.

15. The system of claim 11, wherein the one or more elements of the user interface include a metric input element that presents an option to select the metric from one or more existing metrics associated with the result data of the A/B test.

16. The system of claim 11, wherein the one or more elements of the user interface include a dimension input element that presents an option to select a product-level dimension from one or more dimensions associated with the metric, the product-level dimension representing a feature of a product.

17. The system of claim 11, wherein the one or more elements of the user interface include a dimension input element that presents an option to select a member-level dimension from one or more dimensions associated with the metric, the member-level dimension representing an attribute associated with a member of the social network service (SNS).

18. The system of claim 11, wherein the operations further comprise:
receiving a specification of a cohort via the one or more elements of the user interface of the client device, the cohort including a number of members of a social networking service (SNS) who exhibited a particular behavior during a particular period of time;
identifying the result data of the A/B test pertaining to the cohort based on member identifiers of the members of the cohort; and
performing a cohort analysis pertaining to the cohort based on the result data of the A/B test identified to pertain to the cohort and result data generated during a post-A/B test period of monitoring activity of the members of the cohort.

19. The system of claim 18, wherein the performing of the cohort analysis includes:
accessing the result data of the A/B test pertaining to the cohort;
accessing an indication of an assignment of the members of the cohort to one or more variants of the A/B test;
monitoring the activity of the members of the cohort during the post-A/B test period based on tracking interactions by the members of the cohort with the SNS during the post-A/B test period; and
generating cohort analysis results based on a comparison of the result data of the A/B test identified to pertain to the cohort and the monitored activity of the members of the cohort during the post-A/B test period in light of the indication of the assignment of the members of the cohort to the one or more variants of the A/B test.

20. A non-transitory machine-readable storage medium comprising instructions that, when executed by one or more hardware processors of a machine, cause the one or more hardware processors to perform operations comprising:
causing a display of a user interface for receiving a request of a customized report of result data of an A/B test of online content, the user interface being caused to display on a client device associated with a user, the result data of the A/B test being generated based on an execution of the A/B test by an A/B test system;
receiving, via one or more input elements of the user interface displayed on the client device,
an identifier of the A/B test,
a specification of a metric associated with the result data of the A/B test,
a specification of a dimension of the metric, the dimension being a data field of the metric, and
a specification of a location of the result data of the A/B test in a database associated with the A/B test system;
accessing the result data of the A/B test from the database associated with the A/B test system based on the specification of the location of the result data;
generating the metric based on the identifier of the A/B test, the specification of the metric, and the result data of the A/B test;
generating the customized report pertaining to the dimension of the metric based on the generated metric and the specification of the dimension of the metric; and
causing a display of the customized report in an output element of the user interface of the client device associated with the user.
